(19) United States
(12) Patent Application Publication
(10) Pub. No.: US 2014/0137211 A1
(43) Pub. Date: May 15, 2014

(54) APPARATUS-SPECIFIC INFORMATION GENERATION DEVICE, APPARATUS-SPECIFIC INFORMATION GENERATION METHOD, TERMINAL APPARATUS, AND AUTHENTICATION SYSTEM

(71) Applicants: Kazuhiko Minematsu, Tokyo (JP); Toshihiko Okamura, JP (JP); Yukiyasu Tsunoo, Tokyo (JP)

(72) Inventors: Kazuhiko Minematsu, Tokyo (JP); Toshihiko Okamura, JP (JP); Yukiyasu Tsunoo, Tokyo (JP)

(73) Assignee: NEC CORPORATION, Tokyo (JP)

(21) Appl. No.: 14/129,497

(22) PCT Filed: Jun. 27, 2012
(86) PCT No.: PCT/JP2012/066331

§ 371 Date: Dec. 26, 2013

(30) Foreign Application Priority Data
Jun. 27, 2011 (JP) 2011-141754

(51) Int. Cl. H04L 29/06; G11C 11/406

(52) U.S. Cl. CPC H04L 63/08; G11C 11/406
USPC 726/4; 711/106

(57) ABSTRACT

The present invention has: a dynamic random access memory (DRAM); a refresh controller that receives information related to a range of the number of lost bits that are lost by stopping refresh processing of the DRAM, and controls a time to stop the refresh processing to achieve the range of the number of lost bits; and a physical information mapping unit that generates device specific information based on position information of the lost bits generated by stopping the refresh processing. It is preferable that the refresh controller corrects the time to stop the refresh processing based on the number of current lost bits to achieve the range of the number of lost bits set.

### TECHNICAL FIELD

The present invention relates to a device specific information generating apparatus, a device specific information generating method, a terminal device and an authentication system, and, more particular, relates to a device specific information generating apparatus, a device specific information generating method, a terminal device and an authentication system which generate specific information using an internal physical state of a device.

### BACKGROUND ART

To achieve a safe information/communication system from a viewpoint of information security, authentication processing of determining whether or not a party is valid upon communication between a server and a terminal device needs to be performed. The authentication processing assumes that there is device specific identification information (ID). Although a serial number is exemplary identification information, an attacker who got a valid device can easily obtain this serial number, and serial numbers of other devices can also be predicted from a serial number of a given device.

Further, according to a method of holding an ID of a device or confidential information used for authentication in a memory (ROM) of a terminal device, even though an attacker does not analyze content, if the attacker can copy the memory, the attacker may duplicate an invalid device. There is a problem that a conventional tamper resistant technique which makes it difficult to invalidly read information from a memory in order to deal with such an attack requires high cost.

Recently, as a method of realizing device authentication, a method of generating specific information for a device using physical variation which is inevitably produced in a device which forms a device in manufacturing process is being studied, and is referred to as a “Physically Unclonable Function (PUF)”.

FIG. 1 is a configuration diagram of a specific information generating unit based on a PUF and an authentication system using the specific information generating unit. Authentication is performed between a terminal device 150 and a server 160. The terminal device 150 and the server 160 are connected through a network. An authentication unit 100 of the terminal device 150 has a specific information generating unit 110 and an interface 140. The specific information generating unit 110 has a device physical information generator 120 and a physical information mapping unit 130.

The device physical information generator 120 generally uses a device which originally exists as a component of a terminal device.

The physical information mapping unit 130 converts information obtained by the device physical information generator 120 where necessary, and generates device specific information.

The interface 140 performs interface processing with respect to the server 160, and encrypts device specific information as confidential information and executes an authentication algorithm where necessary.

Non-Patent Literature 1 discloses a method of using randomness of wiring delay which inevitably occurs in manufacturing process.

A method using a Static Random Access Memory (SRAM) takes an advantage of that a default value of each bit upon power activation of a SRAM becomes random. This is disclosed in, for example, Non-Patent Literature 2.

In this case, in FIG. 1, the device physical information generator 120 functions as a SRAM, and input information to be inputted to the device physical information generator 120 is a bit position in the SRAM. In this case, the physical information mapping unit 130 simply outputs a default value of the bit position given as input information upon power activation. Upon authentication of the device terminal 150, the terminal device 150 generates this bit value in advance and registers the bit value in the server 160 in default setting processing. Upon authentication, the server 160 receives the bit value generated by the terminal device 150 then, and checks this bit value and a value registered in default setting processing.

Device specific information based on a PUF not only makes it difficult to predict a value of the device specific information, but also needs to be successfully authenticated in case of a valid device at a higher probability without depending on environment. To improve such reliability, Patent Literature 1 discloses a method of using part of specific information generated by a SRAM instead of entirety of specific information, and calculating values when different temperature or voltage conditions are set as default setting and recording the values in a server to improve such reliability.

Further, Patent Literature 1 describes that it is possible to generate specific information not only in a SRAM but also in a Dynamic Random Access Memory (DRAM) according to the same method. The DRAM expresses “0” and “1” of bits according to a presence of an electric charge of a capacitor (condenser) which forms the element. Even when an electric charge is charged, if the time passes, the electric charge leaks from the capacitor, and a bit value is lost, and therefore the DRAM is required to perform refresh processing of charging the electric charge by performing reading on a regular basis. A loss ratio of each element is determined by capacity of a capacitor or unpredictable variation. By using such characteristics, it is possible to use information of bits which are lost by stopping refresh processing in order to generate specific information.

Upon authentication of a terminal device using device specific information generated by a DRAM, a bit position which is lost by stopping refresh processing is registered in advance in a server in default setting processing, and the server receives a lost bit position generated at the time in the terminal device upon authentication and checks the lost bit position and the bit position registered in default setting.

As a technique related to the present invention, Patent Literature 2 describes a memory formatting method of causing an access control circuit to stop refresh cycles and formatting a memory chip formed with a DRAM in order to format data in a memory system at a high speed and significantly reduce time required for a memory formatting operation (paragraphs [0032] to [0037]).

### CITATION LIST

### Patent Literature

{PTL 1} JP-A-2009-533741
{PTL 2} JP-A-1998-269150

### Non-Patent Literature

{NPL 1} G. E. Shu and S. Devadas, “Physically Unclonable Functions for Device Generation and Secret Key Generation,” Proc. 44th Design Automation Conference, pp. 9-14.
{NPL 2} Daniel E. Holcomb, Wayne P. Burleson, and Kevin Fu, “Power-Up SRAM State as an Identifying Fingerprint and Source of True Random Numbers,” IEEE Trans. Computers, vol. 58, no. 9, pp. 1198-1210, 2009.

### SUMMARY OF INVENTION

### Technical Problem

The time spent until bit loss caused by stopping refresh processing of a DRAM is significantly influenced by a temperature or a voltage, and variation of this influence on each element is comparatively significant. When device specific information is generated using bit positions as is, it is necessary to use a great number of lost bit positions to increase authentication precision, and therefore it is difficult to generate device specific information by effectively using resources of a memory device.

It is an exemplary object of the present invention to provide a device specific information generating apparatus, a device specific information generating method, a terminal device and an authentication system which secure high reliability against an environmental change in, for example, the temperature and the voltage, and effectively use resources of a memory device.

### Solution to Problem

According to a first exemplary aspect of the present invention, a device specific information generating apparatus comprising:

a dynamic random access memory (DRAM);
a refresh controller configured to receive information related to a range of the number of lost bits that are lost by stopping refresh processing of the DRAM, and configured to control a time to stop the refresh processing to achieve the range of the number of lost bits; and
a physical information mapping unit configured to generate device specific information based on position information of the lost bits generated by stopping the refresh processing.

According to a second exemplary aspect of the present invention, a device specific information generating method of a device specific information generating apparatus comprising:

receiving information related to a range of the number of lost bits that are lost by stopping refresh processing of a Dynamic Random Access Memory (DRAM), and controlling a time to stop the refresh processing to achieve the range of the number of lost bits; and
generating device specific information based on position information of the lost bits generated by stopping the refresh processing.

### Advantages Effects of the Invention

According to the present invention, even when default setting processing is performed under a single temperature or voltage condition to generate specific information, it is possible to suppress the number of lost bit positions used upon authentication and perform highly reliable authentication.

### BRIEF DESCRIPTION OF DRAWINGS

FIG. 1 A figure illustrates a block diagram illustrating an example of an authentication system.

FIG. 2 A figure illustrates a block diagram representing a configuration of one embodiment of an exemplary device specific information generating apparatus according to the present invention.

FIG. 3 A figure illustrates a flow representing default setting processing for executing authentication processing of challenge-response between a server and a terminal device in an exemplary authentication system according to the present invention.

FIG. 4 A figure illustrates a flow illustrating processing in which the server authenticates the terminal device in the authentication system according to the present invention.

FIG. 5 A figure illustrates a flow illustrating processing in which the terminal device authenticates the server in the exemplary authentication system according to the present invention.

FIG. 6 A figure illustrates a flow illustrating default setting processing in case that specific information of a fixed ID is generated in the exemplary authentication system according to the present invention.

FIG. 7 A figure illustrates a flow illustrating processing of generating specific information upon the default setting in FIG. 6.

FIG. 8 A figure illustrates a configuration diagram in case that error correction coding is applied in the exemplary authentication system according to the present invention.

FIG. 9 A figure illustrates a flow illustrating default setting processing in case that error correction coding is applied in the exemplary authentication system according to the present invention.

FIG. 10 A figure illustrates a graph illustrating results obtained by actually measuring rates of lost bits with respect to refresh stop time in three DRAMs of a single type.

FIG. 11 A figure illustrates a graph illustrating a result obtained by actually measuring a relationship between a temperature and a loss ratio while the refresh stop time is fixed in a DRAM.

FIG. 12 A figure illustrates a block diagram illustrating a configuration example where a function of the terminal device according to the present invention is configured by a computer.

FIG. 13 A figure illustrates a block diagram illustrating an example of the exemplary authentication system according to the present invention.

### DESCRIPTION OF EMBODIMENTS

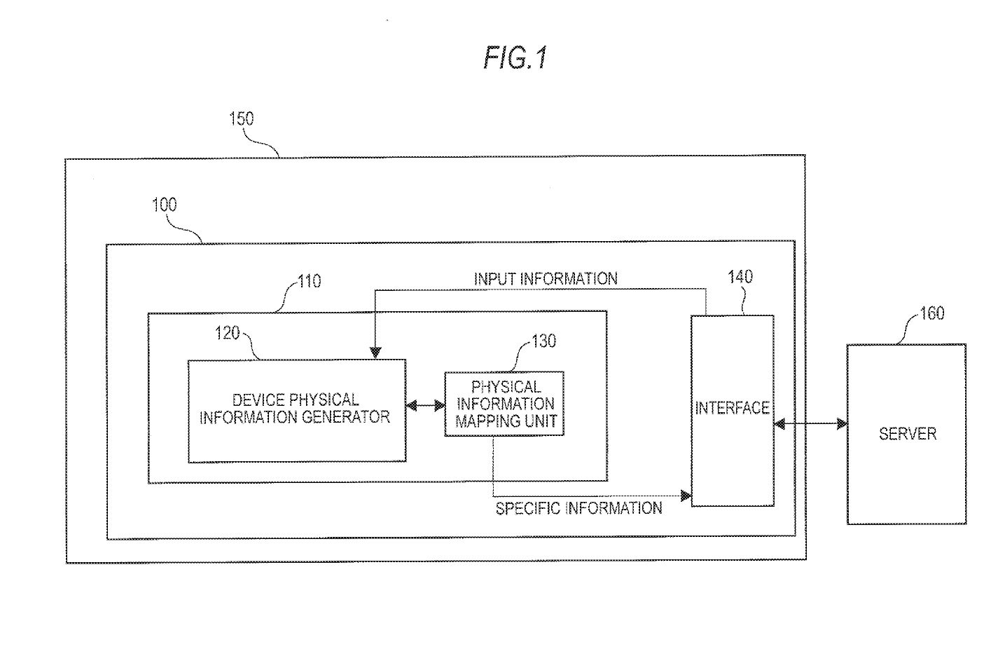

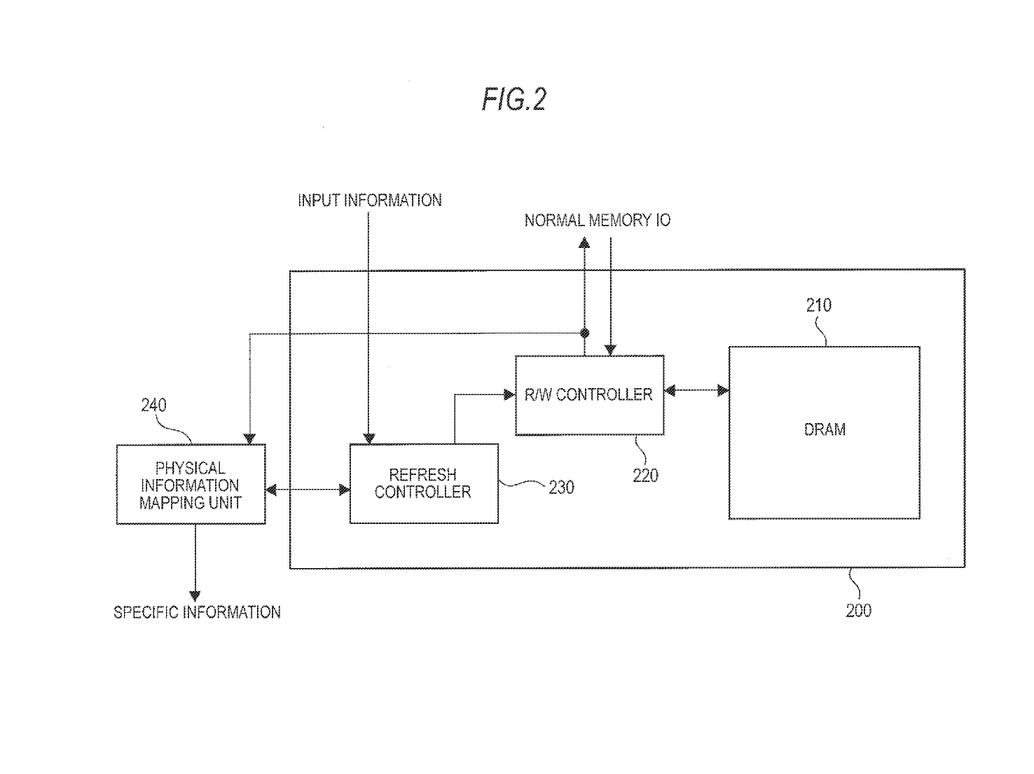

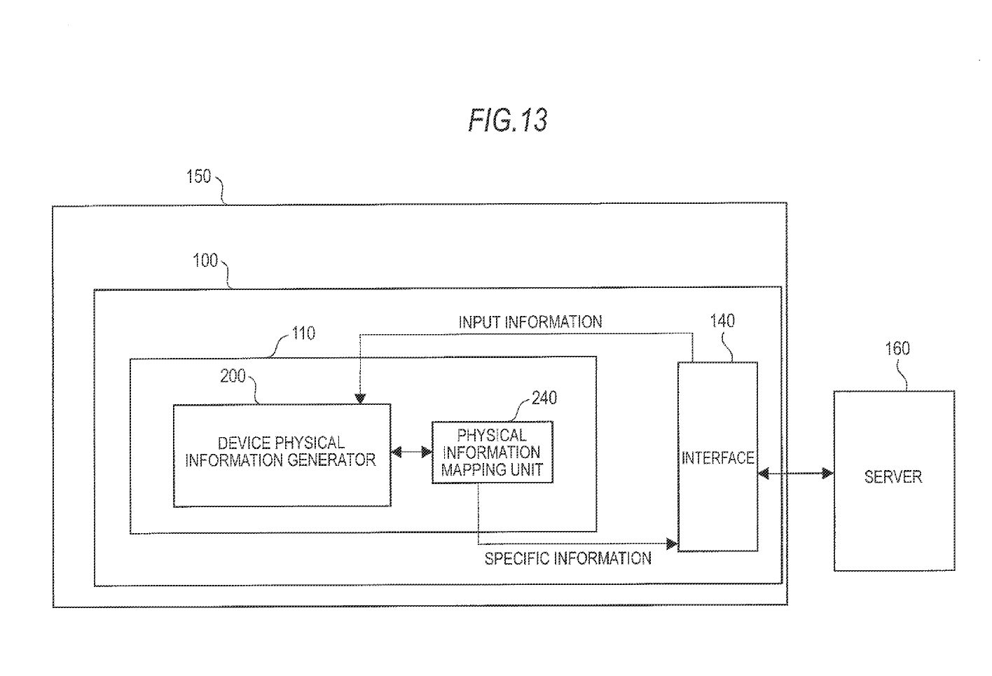

FIG. 2 illustrates a configuration of one embodiment of an exemplary device specific information generating apparatus according to the present invention. The device specific information generating apparatus illustrated in FIG. 2 corresponds to a specific information generating unit 110 in FIG. 1. As illustrated in FIG. 13, the exemplary terminal device and authentication system according to the present invention employ the same configurations as those of a terminal device 150 illustrated in FIG. 1 and an authentication system illustrated in FIG. 1 except that a device physical information generator 120 in FIG. 1 is changed to a device physical information generator 200 and a physical information mapping unit 130 is changed to a physical information mapping unit 240. As illustrated in FIG. 2, the device physical information generator 200 has a DRAM 210, an R/W controller 220 and a refresh controller 230. The DRAM 210 is formed with cells which hold bit values.

The R/W controller 220 reads and writes data from and in the DRAM 210. The DRAM 210 and the R/W controller 220 (including refresh processing) form a normal DRAM configuration.

The refresh controller 230 controls refresh processing with respect to the R/W controller 220 when the DRAM 210 is used to generate specific information. According to the present embodiment, a range of the target number of lost bits is set, and a refresh processing stop time is set such that the refresh controller 230 achieves this number of lost bits or this range. A bit value after charging varies from a region to a region depending on the DRAM 210 in some cases, and the refresh controller 230 executes charge processing which takes this variation into account through the R/W controller 220.

The physical information mapping unit 240 performs processing of specifying positions of lost bits produced by stopping refresh processing, and converting the lost bit positions into a bit sequence which is used as device specific information. The physical information mapping unit 240 may be integrated with the refresh controller 230.

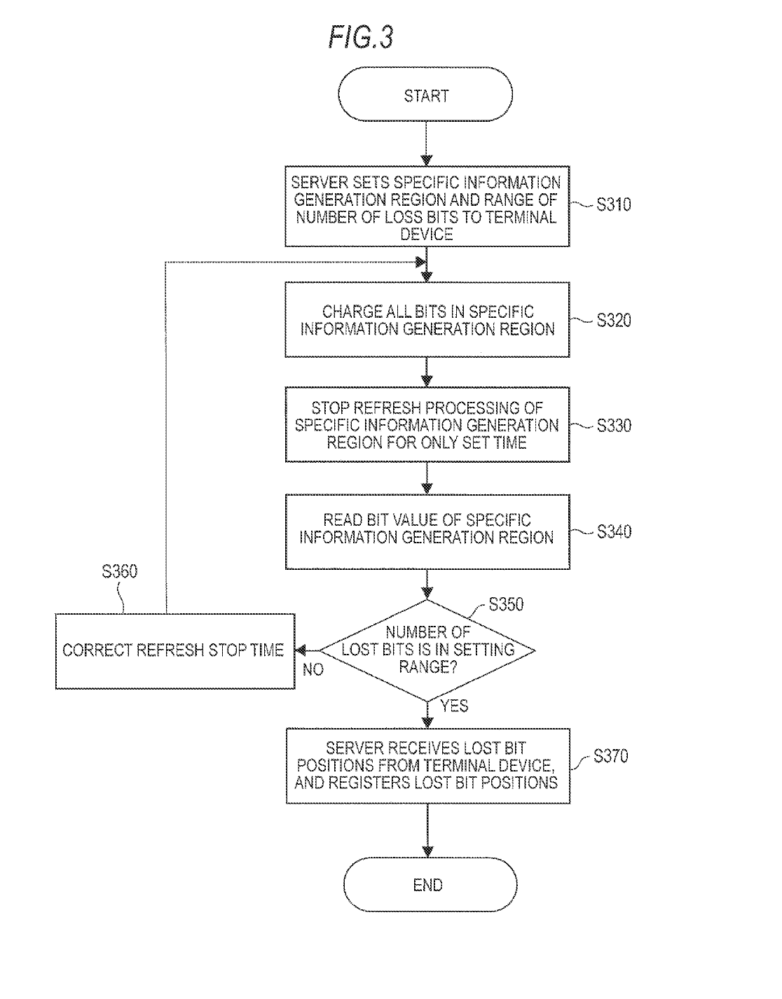

FIG. 3 illustrates a flow representing default setting processing for executing authentication processing of challenge-response between a server and a terminal device using the present embodiment.

The server 160 sets a memory region (specific information generation region) and the range of the number of lost bits used to generate specific information, as input information to the terminal device 150 (step S310). The specific information generation region may be an entire memory. These pieces of information may also be held in a terminal device in advance.

Following steps S320 to S360 are executed in the terminal device, and step S370 is executed in the server.

The R/W controller 220 executes charge processing for all bits in the specific information generation region set in step S310 (step S320).

The refresh controller 230 stops refresh processing of the specific information generation region of the DRAM 210 only for a specified time (step S330).

After stopping the refresh processing in step S330, the R/W controller 220 reads a bit value of the specific information generation region (step S340).

The physical information mapping unit 240 checks whether or not the number of lost bits detected in step S340 is in a setting range set in step S310 (step S350).

When the number of lost bits is not in the setting range in step S350 (No in step S350), a refresh processing stop time is corrected, and the flow returns to step S320 (step S360).

When the number of lost bits is in the setting range in step S350 (Yes in step S350), the server 160 receives information of lost bit positions in step S340 through the interface 140 of the terminal device 150 and registers the information (step S370). Upon transmission of this information, there are a method of transmitting the bit sequence in step S340 as is and a method of finding lost bit positions (bit positions inverted from a charged bit value) from this bit sequence and transmitting the lost bit positions. When the number of lost bits in a specific information generation region is smaller, the latter method provides a smaller amount of communication.

A first setting of the refresh processing stop time in step S320 can be set by the server 160 in step S310 or stored in the terminal. When information related to the temperature or the voltage can be obtained, the refresh processing stop time may be set based on this information.

The refresh stop processing time is corrected in step S360 by decreasing a stop time when the current number of lost bits is larger than the setting range, and increasing the stop time when the current number of lost bits is smaller than the setting range.

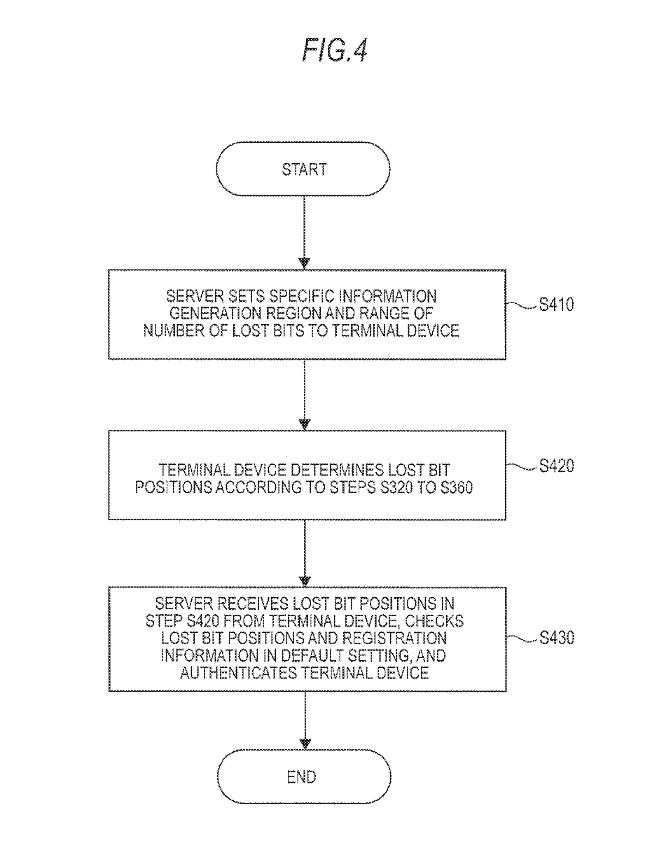

Next, a method of authenticating the terminal device in default setting processing in FIG. 3 will be described using the flow in FIG. 4. In the server, information of lost bit positions upon default setting has already been registered.

The server 160 specifies a specific information generation region and a range of the number of lost bits used to authenticate the terminal device 150 (step S410). This specific information generation region is a region included in the specific information generation region in default setting (step S310), and the range of the number of lost bits is determined based on the number of lost bits in default setting. In this case, preferably, the number of lost bits upon authentication is set to the number of lost bits in default setting or less.

The terminal device determines lost bit positions according to the flow (steps S320 to S360) in FIG. 3 under the condition in step S410 (step S420).

The server receives information of the lost bit positions in step S420 from the terminal device, and checks the information and the registration information upon default setting to authenticate the terminal device (step S430).

Although a loss ratio of an electric charge of each element of the DRAM changes according to a temperature or voltage condition, elements loss speeds of which are significantly different under a given condition are expected to maintain to some degree a relative relationship between the loss ratios even when this condition is different. The first k (k is a positive integer) lost bit positions under a given temperature and voltage condition in particular are included at a high probability in the first m (m is a positive integer) lost bit positions where m is sufficiently larger than k even when this condition is different. That is, by setting k which is sufficiently smaller than m to the number of lost bits in step S410 upon authentication compared to the m lost bit positions in default setting in FIG. 3, the lost bit positions are included at a higher probability in a set of lost bit positions registered in default setting. By increasing this probability, it is possible to accurately perform authentication even when the number of lost bit positions used in step S540 is decreased.

There is a method of performing authentication plural time by using and disposing a specific information generation region used in the flow upon authentication in FIG. 4 as a partial region of the specific information generation region upon default setting every time authentication is executed. Further, there is also a method of changing a specific information generation region when authentication succeeds in the flow in FIG. 4, executing the default setting in FIG. 3 and preparing for next authentication.

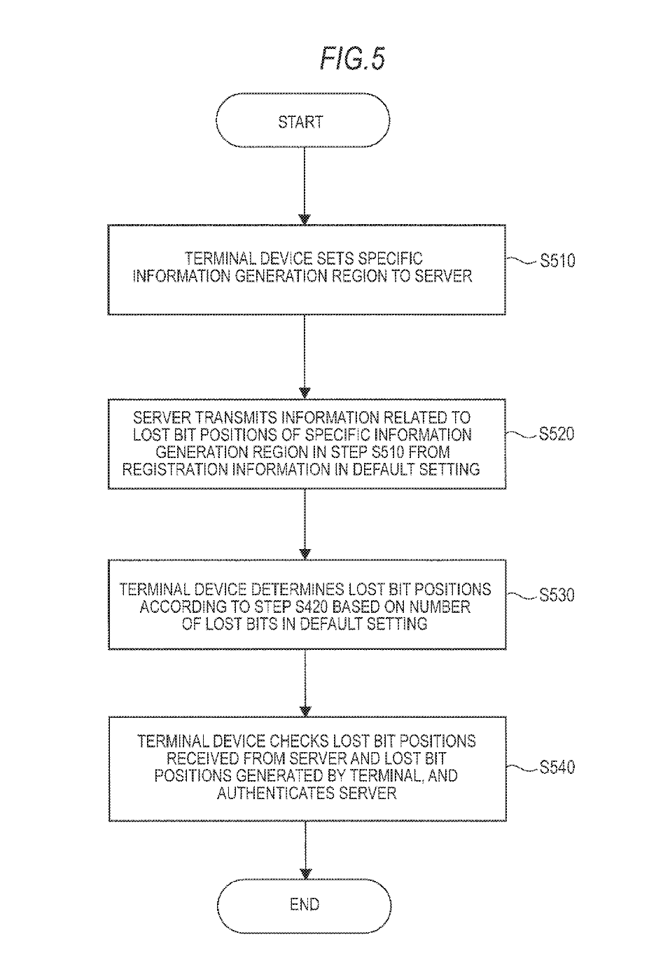

Meanwhile, there is a method of storing in a terminal device a specific information generation region and the number of lost bits in default setting to prevent an invalid server from reading device specific information of a terminal device according to the present embodiment in the flow in FIG. 4, and making the terminal device to authenticate the server. FIG. 5 illustrates this flow.

The terminal device 150 specifies a specific information generation region used for the server 160 this time upon authentication (step S510).

The server 160 transmits information related to lost bit positions in the specific information generation region specified in step S510 from device specific information held upon default setting (step S520).

The terminal device determines lost bit positions according to the flow (steps S420 to

S430) in FIG. 4 based on the number of lost bits in default setting (step S530).

The terminal device checks the information related to the lost bit positions from the server in step S520 and the lost bit positions in step S530, and authenticates the server (step S540).

By setting the range of the number of lost bits to the number of lost bits obtained upon default setting or more in step S530, the terminal device can increase the probability that lost bit positions transmitted from a valid terminal can be accurately matched. Consequently, it is possible to accurately perform authentication even when the number of lost bit positions transmitted from the server is decreased.

There may also be a method of storing a used specific information generation region in the server and the terminal device in the flows in FIGS. 4 and 5, and selecting an unused specific information generation region in steps S410 and S510.

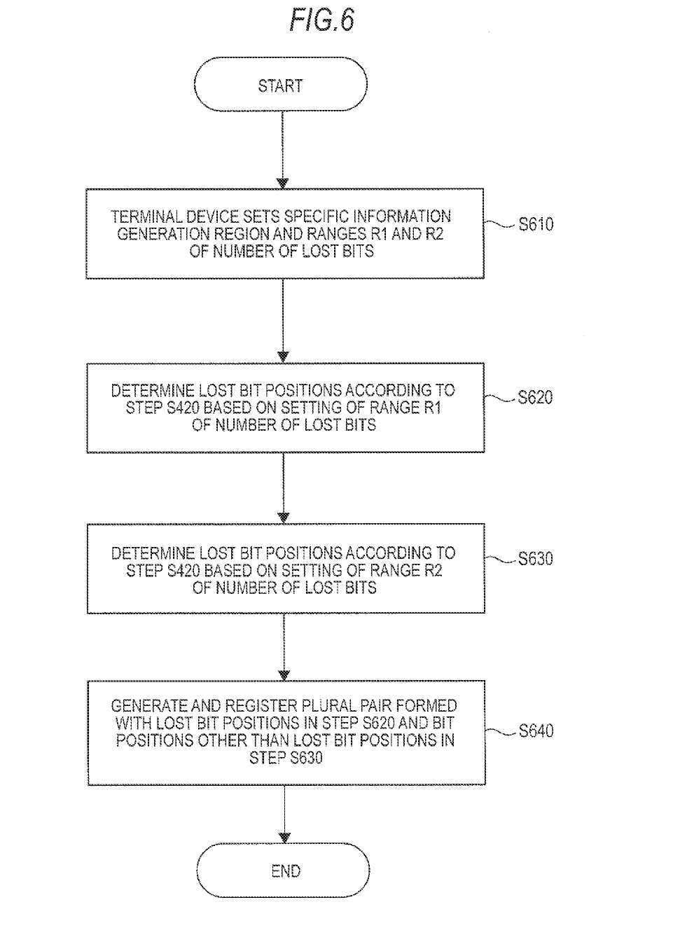

When it is possible to generate a fixed ID from device specific information, the interface 140 in FIG. 1 can realize a security function by executing encryption or an authentication algorithm using this fixed ID. To generate a fixed ID from device specific information, an identical value is preferably generated at a high probability even when a temperature or voltage condition changes. By finding pairs of bit positions electric charge loss speeds of which are significantly different in default setting processing using the present embodiment, it is possible to generate such a fixed ID. FIG. 6 illustrates a flow of default setting processing which achieves generation of this fixed ID.

The terminal device sets memory regions (specific information generation regions) and the ranges R1 and R2 of the number lost bits used to generate specific information (step S610). The number of lost bits in the range R2 is higher than the number of lost bits in the range R1. There are a method of holding these pieces information in advance in the terminal device and a method of sending these pieces of information from the server as in step S310.

The refresh controller 230 sets a refresh processing stop time such that the number of lost bits is in the range R1 similar to step S520, and finds lost bit positions at this point of time (step S620).

The refresh controller 230 sets a refresh processing stop time such that the number of lost bits is in the range R2 similar to step S520, and finds lost bit positions at this point of time (step S630).

The physical information mapping unit 240 forms plural pair obtained by selecting the lost bit positions in step S620 and bit positions other than the lost bit positions in step S630, and holds the lost bit positions and the bit positions in a random order in the pair (step S640). When the server specifies an ID, the order in the pair is determined according to a bit value. To store pairs, there are a method of holding the pairs in the terminal and a method of holding the pairs in the server.

While electric charges are lost very fast at the bit positions in step S620, the bit positions other than the bit positions calculated in step S630 are bit positions the electric charge loss speeds of which are guaranteed to be sufficiently slow compared to the bit positions calculated in step S620. By controlling the number of lost bits at two stages using the present embodiment in this way and finding lost bit positions, it is possible to generate pairs of bit positions electric charge loss speeds of which are significantly different.

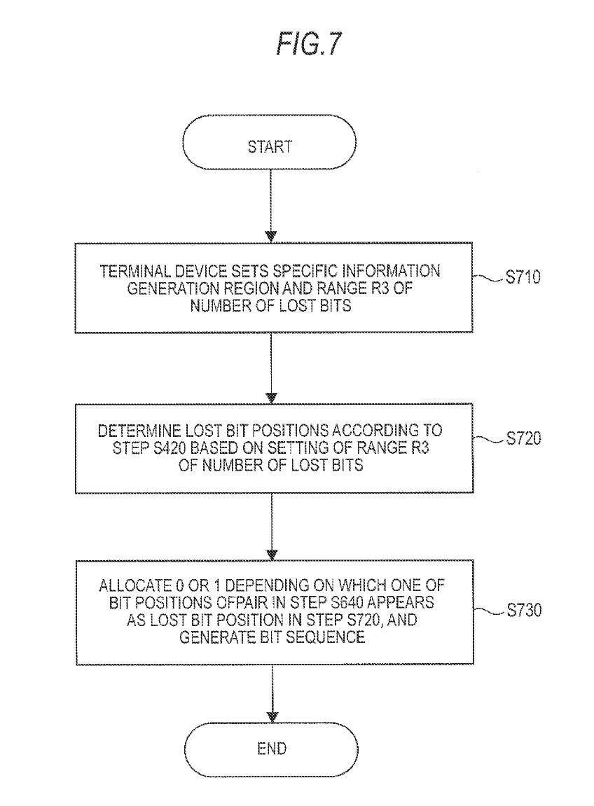

FIG. 7 illustrates a flow of specific information generation processing upon default setting in FIG. 6.

The server supplies a memory region (specific information generation region) and the range R3 of the number of lost bits used to generate specific information to the terminal device (step S710). The range R3 of the number of lost bits is set between the range R1 of the number of lost bits and the range R2 of the number of lost bits. Similar to step S610, the range R3 may not be supplied from the server, and may be held in the terminal device in advance.

The refresh controller 230 sets a refresh processing stop time such that the number of lost bits is in the range R3 similar to step S520, and fids lost bit positions at this point of time (step S720).

The physical information mapping unit 240 determines “0” or “1” according to which one of bit positions of the pair of the bit positions in step S640 appear as lost bit positions in step S720 (step S730).

By adequately setting the range R3, loss bit positions generated in step S720 are expected to include first R1 lost bit positions under each temperature condition, and are expected to be included in the first R2 lost bit positions under each temperature condition. That is, one of the bit positions of the pair in step S640 stably become lost bit positions, and each bit generated in step S730 takes a fixed value at a high probability.

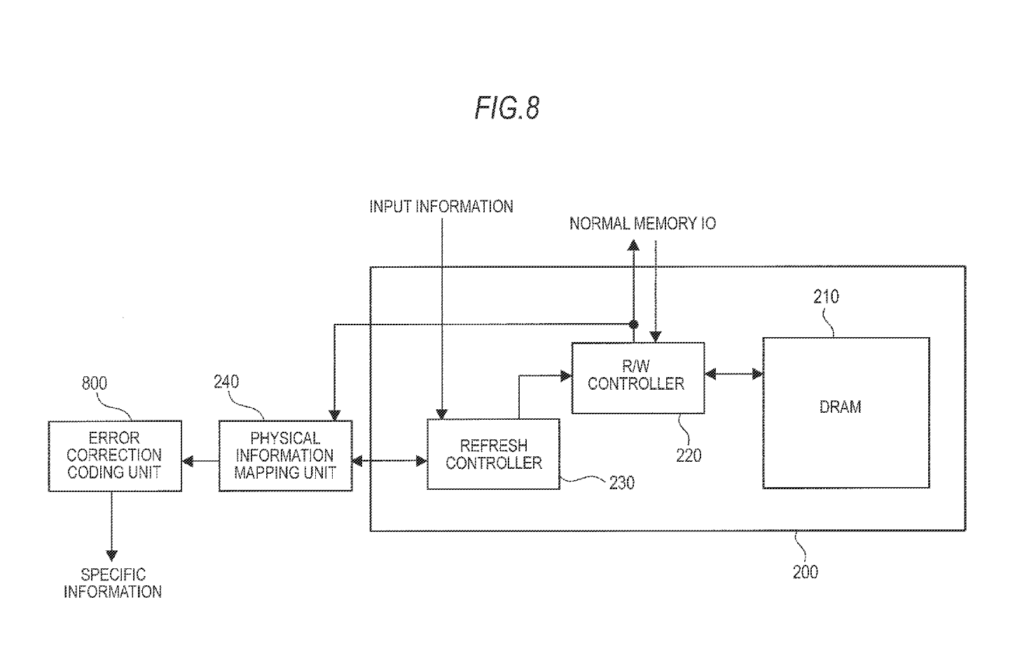

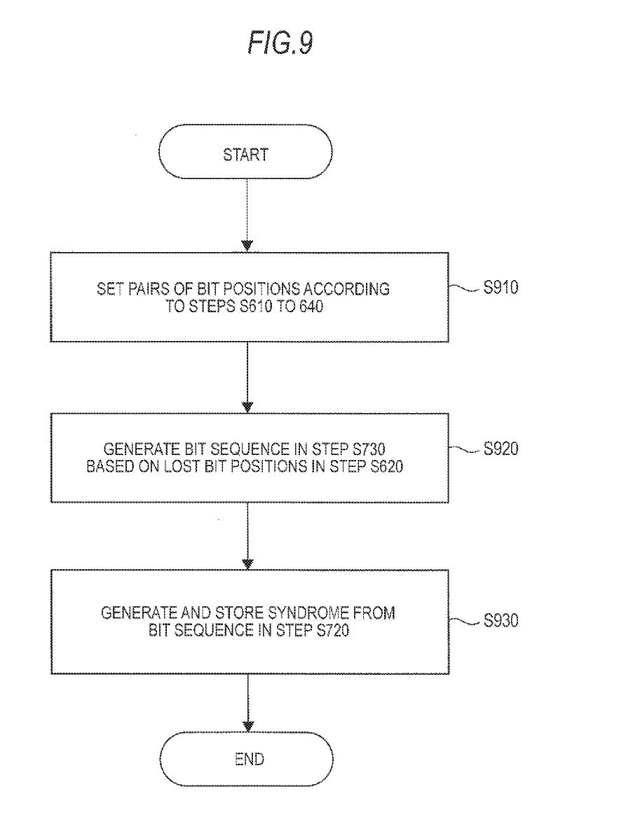

To further increase reliability, error correction coding is applied as described in Patent Literature 1. FIG. 8 is a view illustrating a configuration in this case, and an output of the physical information mapping processing unit 240 is sent to an error correction coding unit 800. FIG. 9 illustrates an example of this default setting flow in the error correction coding unit 800.

Pairs of bit positions are generated and stored according to steps S610 to S640 (step S910).

A bit sequence is generated according to the method in step S730 based on the bit loss positions in step S910 (step S920).

A syndrome of error correction coding is calculated from the bit sequence in step S920 and stored (step S930).

Upon generation of specific information, the bit sequence is generated based on step S730 of default setting, and correction processing is executed using the syndrome in step S930. To improve reliability, there is a method of executing step S720 plural time and increasing accuracy of loss positions. Further, there may also be a method of dividing the bit sequence in step S920 into some sequences in step S930, and applying error correction coding per sequence.

### Example

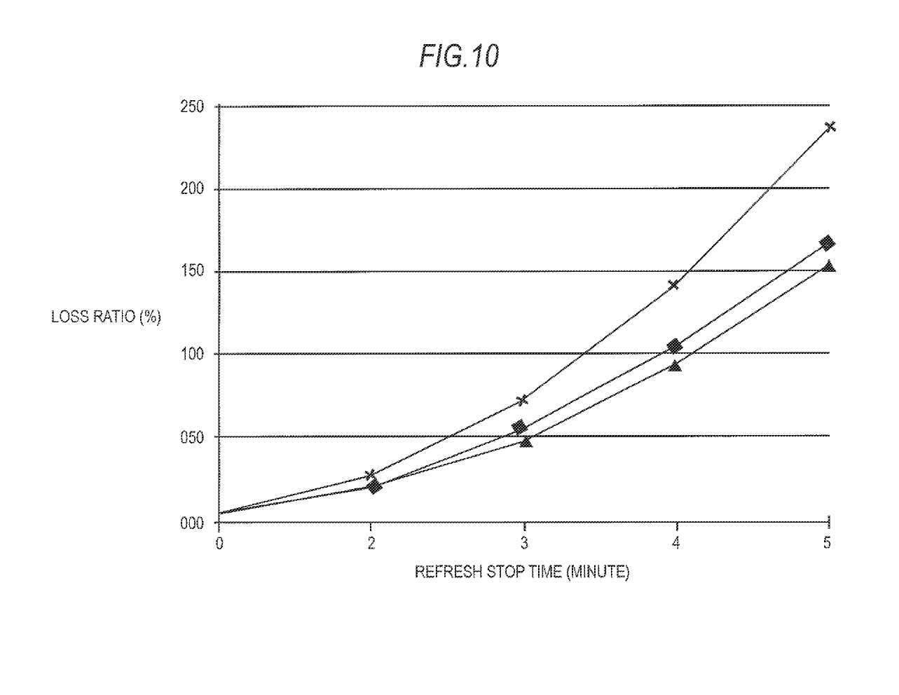

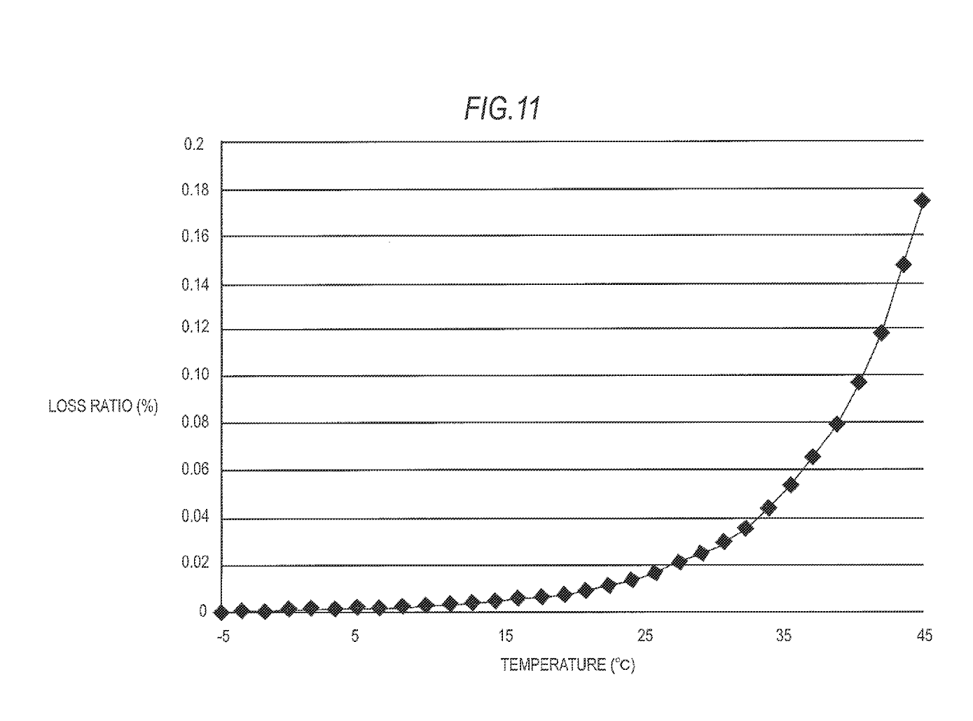

FIG. 10 illustrates a graph representing results obtained by measuring times at which refresh processing of three DRAMs (capacity is N=64M=64×2²⁰ bits) of the same type is stopped at a normal temperature, and the number of lost bits. A vertical axis of the graph represents a loss ratio (%) which is a ratio of the number of lost bits to all bits. FIG. 11 illustrates a graph representing a temperature and a loss ratio when the refresh stop time is fixed.

As is clear from the graph in FIG. 10, a relationship between the refresh stop time and the number of lost bits is comparatively linear when the number of lost bits is smaller, and, therefore, when the number of lost bits is outside the setting range in step S430, correcting the refresh stop time based on this ratio is one method. That is, there is a method of executing processing of correcting the refresh processing stop time to half when the current number of lost bits is about twice as much as a specified range, and finding lost bit positions again. The relationship between the refresh processing stop time and the number of lost bits smoothly changes at a fixed temperature as illustrated in FIG. 10, so that, by setting a large setting range of the number of lost bits to some degree (for example, ±10% of the number of lost bits) and repeating this processing several times, the number of lost bits can be expected to settle in the setting range. When the terminal device has a temperature sensor, there is a method of calculating a graph in FIG. 11 in advance, and setting a default value of a refresh processing stop time determined in relation to this graph.

Upon authentication processing of the terminal device illustrated in FIGS. 3 and 4, the number of lost bit positions registered upon default setting is m (m is a positive integer), the number of lost bit positions generated upon authentication is k (k is a positive integer), and a probability that lost bit positions generated upon authentication is p(m, k). Upon authentication using u (u is a positive integer) lost bit positions, (k/u) is the number of times authentication processing can be executed under a condition that the lost bit positions are used only once in authentication, and is an index to effectively use resources upon generation of specific information of the DRAM. For ease of description, a criterion to determine a device terminal as a valid device terminal when the number of lost bit positions registered upon default setting among the u lost bit positions is one or more will be studied. A probability (rate of rejection faultily) to determine a valid terminal device as an invalid terminal device is evaluated by P in {equation 1}.

P=(1−p(m,k))^{u} {Equation 1}

Meanwhile, as a result of checking positions at which first 1000 lost bits are produced in ten DRAMs of the same type as the DRAMs used in FIGS. 10 and 11, an experiment result that there was no match between devices and lost bits were uniformly distributed was obtained. There was no bias of a bit level of a word (16 bits in a device in this case). That is, in this experiment, the result may be considered that the first 1000 lost bit positions were independent per device. A probability (false acceptance rate) that a device which is not a valid device under assumption of this independence is determined as a valid device will be studied. When the same determination criterion as that of P is taken into account, this probability is a probability that one of u lost bit positions or more generated by a given device match with the m lost bit positions registered upon default setting of another device, and is evaluated by Q in {equation 2}. N (N is a positive integer) is the number of bits in a specific information generation region, and B(a, b) is a binominal coefficient which is the number of combinations for selecting b out of a.

Q=1−B(N−m,u)/B(N,u) {Equation 2}

To accurately perform authentication, P and Q both need to be decreased. By increasing u in {equation 1} or setting small k compared to m and increasing p(m, k), it is possible to decrease P. Meanwhile, to decrease Q in {equation 2}, small m (necessarily small k) is set compared to high u.

This time, lost bit positions in each device were checked by setting the number of lost bits to 100 and 1000 at temperatures of −5° C., 10° C., 25° C. and 45° C. in the DRAMs used in FIGS. 10 and 11, and adjusting refresh processing stop times. About k/2 lost bit positions were commonly the first k lost bit positions at all temperatures. That is, an upper limit of p(k, k) is evaluated as ½. When p(k, k)=½ is assumed and P<10⁻³ is a criterion of reliability of authentication, u=10 is required. By contrast with this, in case of m=1000 and k=100, p(m, k)=1 held in the experiment. Generally, when it is assumed that p(10k, k)≧0.99 holds in case of m=10k in this device, u=2 is required to achieve authentication precision of P<10⁻³.

As to Q, when Q<10⁻³ is a criterion of reliability of authentication, if, for example, N=10⁶ holds, m=100 is almost an upper limit in case of u=10 and m=500 is almost an upper limit in case of u=2. That is, when the number of lost bits is set to m=k=100, authentication can be executed k/u=10 times, and, when the number of lost bits is set to m=500 and k=50, authentication can be executed k/u=25 times. Thus, by adequately setting m and k and controlling a refresh stop time as in the present embodiment, it is possible to generate specific information by effectively using resources of a DRAM.

As settings of the ranges R1, R2 and R3 upon generation of fixed IDs as specific information illustrated in FIGS. 6 and 7, for example, the range R1 is about 100, the range R2 is about 10,000 and the range R3 is about 1,000 in a DRAM used in the experiment. At whatever temperature, lost bit positions which appear as lost bit positions in the first range R1 in each device appear as lost bit positions of the first range R3, and, at whatever temperature, lost bit positions of the first range R3 appear as lost bit positions of the first range R2. That is, by making R1 pairs of lost bit positions of the range R1 and bit positions other than the lost bit positions of the range R2 under a given temperature or voltage condition in step S640, and performing control at the refresh controller such that lost bits of the range R3 can be obtained by specific information generation processing, one of bits become lost bits at a high probability and a fixed ID with the number of bits corresponding to about R1 can be highly reliably generated.

Upon error correction coding in FIGS. 8 and 9, BCH coding is typically applied. By using output bits corresponding to a pair of bits which are both lost upon generation of a fixed ID in FIG. 7 or which are not both lost as “lost bits” upon decoding processing in error correction coding, it is possible to apply a loss decoding algorithm and improve decoding processing performance.

According to the present embodiment, even when default setting processing is performed under a single temperature or voltage condition upon generation of specific information, it is possible to suppress the number of lost bit positions used upon authentication and perform highly reliable authentication. It is possible to highly reliably generate a fixed ID in particular, and achieve various security functions by using the fixed ID as a private key or a private ID for encryption or an authentication algorithm.

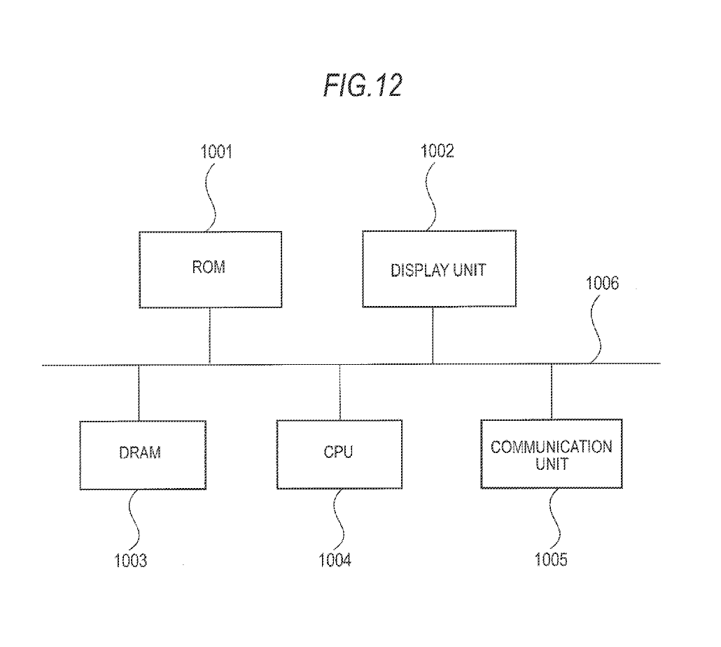

Although a device specific information generating apparatus and a terminal device according to the above embodiment and example are formed by hardware such as dedicated ICs, functions of the device specific information generating apparatus and the terminal device can be realized by software. The functions of the device specific information generating apparatus and the terminal device can be realized when a program which realizes the functions is read from a computer-readable recording medium such as a CD-ROM, a DVD or a flash memory and executed by a computer. FIG. 12 is a block diagram illustrating one configuration example where functions of a terminal device according to the present invention are configured by a computer. The computer has a ROM 1001 which stores programs, a display unit 1002 such as a liquid display, a DRAM 1003, a CPU 1004, a communication unit 1006 which performs communication with the server and a bus 1006 which connects with each unit. By describing operations of the device specific information generating apparatus and the terminal device as illustrated in FIGS. 3 to 7 and 8 as programs, storing the programs in the ROM 1001 and storing information required for computation in the DRAM 1003 and causing the CPU to operate the programs, the functions of the device specific information generating apparatus and the terminal device hone reception control unit according to the present embodiment and the example can be realized by the programs. The programs describe part or all of operations of the refresh controller 230, the R/W controller 220, the physical information mapping unit 240 and the error correction coding unit 800 illustrated in FIGS. 2 and 8.

Although the exemplary embodiment of the present invention has been described above, the present invention can be implemented in other various modes without deviating from the spirit or main features defined by the claims of this application. Hence, the above-described embodiment is only an exemplary embodiment, and should not be interpreted in a limited way. The scope of the present invention is indicated by the claims, and is not restricted by the disclosure of the specification and the abstract. Further, modification or change to an equivalent scope of the claims is entirely incorporated in the scope of the present invention.

This application claims priority to Japanese Patent Application No. 2011-141754 filed on Jun. 27, 2011. Further, the entire contents disclosed in Japanese Patent Application No. 2011-141754 are incorporated by reference herein

Although part or entirety of the embodiment can be described as in the supplementary notes, the embodiment is not limited to the following configuration.

(Supplementary Note 1)

A device specific information generating apparatus comprising:

a dynamic random access memory (DRAM);
a refresh controller configured to receive information related to a range of the number of lost bits that are lost by stopping refresh processing of the DRAM, and configured to control a time to stop the refresh processing to achieve the range of the number of lost bits; and
a physical information mapping unit configured to generate device specific information based on position information of the lost bits generated by stopping the refresh processing.

(Supplementary Note 2)

The device specific information generating apparatus according to Supplementary note 1, wherein the refresh controller corrects the time to stop the refresh processing based on the number of current lost bits to achieve the range of the number of lost bits set.

(Supplementary Note 3)

A terminal device comprising the device specific information generating apparatus according to Supplementary note 1 or 2.

(Supplementary Note 4)

An authentication system comprising:

the terminal device according to Supplementary note 3; and
a server that is connected with the terminal device through a network, wherein:
the terminal device transmits device specific information generated by the device specific information generating apparatus in default setting processing, to the server, and the server holds the device specific information; and
upon authentication of the terminal device, the terminal device generates device specific information and transmits part of the device specific information to the server, and the server checks the device specific information received upon the authentication and the device specific information held in the default setting processing to authenticate the terminal device.

(Supplementary Note 5)

The authentication system according to Supplementary note 4, wherein, upon the authentication of the terminal device, the number of lost bits is set to the number of lost bits in the default setting processing or less.

(Supplementary Note 6)

The authentication system according to Supplementary note 4, wherein:

the server transmits part of the device specific information held in the default setting processing, to the terminal device; and
the terminal device generates device specific information, and checks the device specific information and the received device specific information to authenticate the server.

(Supplementary Note 7)

The authentication system according to Supplementary note 6, wherein, upon authentication of the server, the number of lost bits is set to the number of lost bits in the default setting processing or more.

(Supplementary Note 8)

The device specific information generating apparatus according to Supplementary note 1 or 2, wherein:

a first range R1 and a second range R2 are specified as ranges of the number of lost bits in default setting processing;
the number of lost bits specified by the second range R2 is set higher than the number of lost bits specified by the first range R1;
the refresh controller finds a position of a lost bit in the first range R1;
the refresh controller finds a position of a lost bit in the second range R2;
a plurality of pairs of positions of lost bits that are in the first range R1 and bit positions that are not in the second range R2 is generated and held; and
a range R3 of the number of lost bits which is an intermediate between the first range R1 and the second range R2 is specified upon use of the device specific information, and a bit sequence is generated as the device specific information based on which one of bit positions of the pair is lost.

(Supplementary Note 9)

A device specific information generating method of a device specific information generating apparatus comprising:

receiving information related to a range of the number of lost bits that are lost by stopping refresh processing of a Dynamic Random Access Memory (DRAM), and controlling a time to stop the refresh processing to achieve the range of the number of lost bits; and
generating device specific information based on position information of the lost bits generated by stopping the refresh processing.

(Supplementary Note 10)

The device specific information generating method according to Supplementary note 9, further comprising correcting the time to stop the refresh processing based on the number of current lost bits to achieve the range of the number of lost bits set.

(Supplementary Note 11)

A program causing a computer to execute: a refresh controlling function of receiving information related to a range of the number of lost bits that are lost by stopping refresh processing of a Dynamic Random Access Memory (DRAM), and controlling a time to stop the refresh processing to achieve the range of the number of lost bits; and a physical information mapping function of generating device specific information based on position information of the lost bits generated by stopping the refresh processing.

(Supplementary Note 12)

The program described in supplementary note 11, further has a function of correcting a time to stop the refresh processing based on the number of current lost bits to achieve the range of the number of lost bits set.

### INDUSTRIAL APPLICABILITY

The present invention can be used for device authentication of a terminal device or a server.

### REFERENCE SINGS LIST

100 AUTHENTICATION UNIT
110 SPECIFIC INFORMATION GENERATING UNIT
120, 200 DEVICE PHYSICAL INFORMATION GENERATOR
130, 240 PHYSICAL INFORMATION MAPPING UNIT
140 INTERFACE
150 TERMINAL DEVICE
160 SERVER
210 DRAM
220 R/W CONTROLLER
230 REFRESH CONTROLLER
S310 to S350, S610 to S640 STEPS OF DEFAULT SETTING FLOW
S410 to S450 STEPS OF TERMINAL DEVICE AUTHENTICATION PROCESSING FLOW
S710 to S740 STEPS OF FIXED ID GENERATING FLOW IN TERMINAL DEVICE
800 ERROR CORRECTION CODING UNIT
S910 to S930 STEPS OF DEFAULT SETTING FLOW UPON APPLICATION OF ERROR CORRECTION CODING

1. A device specific information generating apparatus comprising:
a dynamic random access memory (DRAM);
a refresh controller configured to receive information related to a range of the number of lost bits that are lost by stopping refresh processing of the DRAM, and configured to control a time to stop the refresh processing to achieve the range of the number of lost bits; and
a physical information mapping unit configured to generate device specific information based on position information of the lost bits generated by stopping the refresh processing.

2. The device specific information generating apparatus according to claim 1, wherein the refresh controller corrects the time to stop the refresh processing based on the number of current lost bits to achieve the range of the number of lost bits set.

3. A terminal device comprising the device specific information generating apparatus according to claim 1.

4. An authentication system comprising:
the terminal device according to claim 3; and
a server that is connected with the terminal device through a network, wherein:
the terminal device transmits device specific information generated by the device specific information generating apparatus in default setting processing, to the server, and the server holds the device specific information; and
upon authentication of the terminal device, the terminal device generates device specific information and transmits part of the device specific information to the server, and the server checks the device specific information received upon the authentication and the device specific information held in the default setting processing to authenticate the terminal device.

5. The authentication system according to claim 4, wherein, upon the authentication of the terminal device, the number of lost bits is set to the number of lost bits in the default setting processing or less.

6. The authentication system according to claim 4, wherein:
the server transmits part of the device specific information held in the default setting processing, to the terminal device; and
the terminal device generates device specific information, and checks the device specific information and the received device specific information to authenticate the server.

7. The authentication system according to claim 6, wherein, upon authentication of the server, the number of lost bits is set to the number of lost bits in the default setting processing or more.

8. The device specific information generating apparatus according to claim 1, wherein:
a first range R1 and a second range R2 are specified as ranges of the number of lost bits in default setting processing;
the number of lost bits specified by the second range R2 is set higher than the number of lost bits specified by the first range R1;
the refresh controller finds a position of a lost bit in the first range R1;
the refresh controller finds a position of a lost bit in the second range R2;
a plurality of pairs of positions of lost bits that are in the first range R1 and bit positions that are not in the second range R2 is generated and held; and
a range R3 of the number of lost bits which is an intermediate between the first range R1 and the second range R2 is specified upon use of the device specific information, and a bit sequence is generated as the device specific information based on which one of bit positions of the pair is lost.

9. A device specific information generating method of a device specific information generating apparatus comprising:
receiving information related to a range of the number of lost bits that are lost by stopping refresh processing of a Dynamic Random Access Memory (DRAM), and controlling a time to stop the refresh processing to achieve the range of the number of lost bits; and
generating device specific information based on position information of the lost bits generated by stopping the refresh processing.

10. The device specific information generating method according to claim 9, further comprising correcting the time to stop the refresh processing based on the number of current lost bits to achieve the range of the number of lost bits set.

11. The device specific information generating method according to claim 9, the device specific information generating apparatus is included in a terminal device.
